(19) United States
(12) Patent Application Publication
(10) Pub. No.: US 2017/0105573 A1
(43) Pub. Date: Apr. 20, 2017

(54) Cooking Assembly

(71) Applicant: Steven Atkisson, Thornton, CO (US)

(72) Inventor: Steven Atkisson, Thornton, CO (US)

(21) Appl. No.: 14/887,906

(22) Filed: Oct. 20, 2015

(51) Int. Cl. A47J 37/07

(52) U.S. Cl. CPC A47J 37/07

(57) ABSTRACT

A cooking assembly includes a housing that may contain a food item. A first grill is removably positioned within the housing and the first grill may support the food item. A cooker is removably positioned within the housing. The cooker may contain a combustible material thereby facilitating the food item to be cooked when the cooker is positioned within the housing. The cooker is removable from the housing. Thus, the cooker may cook the food item in a remote location with respect to the housing.

### BACKGROUND OF THE DISCLOSURE

Field of the Disclosure

The disclosure relates to cooking devices and more particularly pertains to a new cooking device having a portable cooker being removably positioned within a housing.

### SUMMARY OF THE DISCLOSURE

An embodiment of the disclosure meets the needs presented above by generally comprising a housing that may contain a food item. A first grill is removably positioned within the housing and the first grill may support the food item. A cooker is removably positioned within the housing. The cooker may contain a combustible material thereby facilitating the food item to be cooked when the cooker is positioned within the housing. The cooker is removable from the housing. Thus, the cooker may cook the food item in a remote location with respect to the housing.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a cooking assembly according to an embodiment of the disclosure.

FIG. 2 is a front view of an embodiment of the disclosure.

FIG. 3 is a cross sectional view taken along line 3-3 of FIG. 2 of an embodiment of the disclosure.

FIG. 4 is a top view of an embodiment of the disclosure.

FIG. 5 is a cross sectional view taken along line 5-5 of FIG. 4 of an embodiment of the disclosure.

FIG. 6 is a bottom view of an embodiment of the disclosure.

### DESCRIPTION OF THE PREFERRED EMBODIMENT

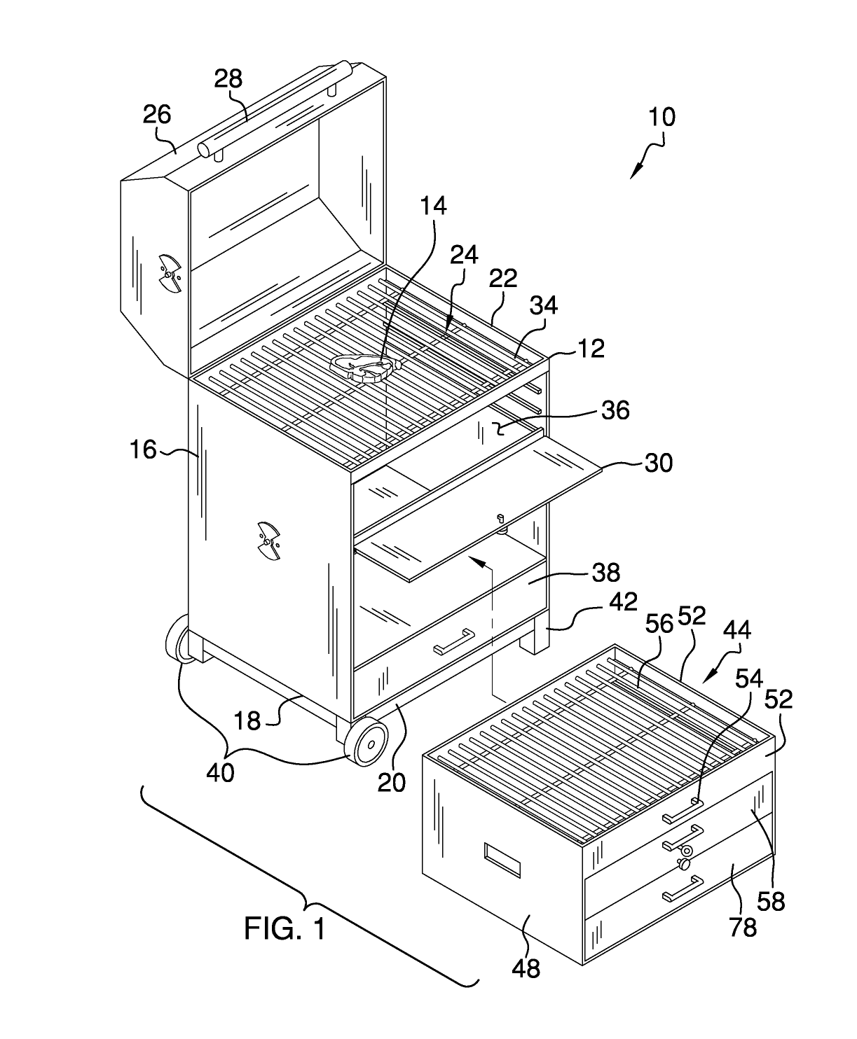

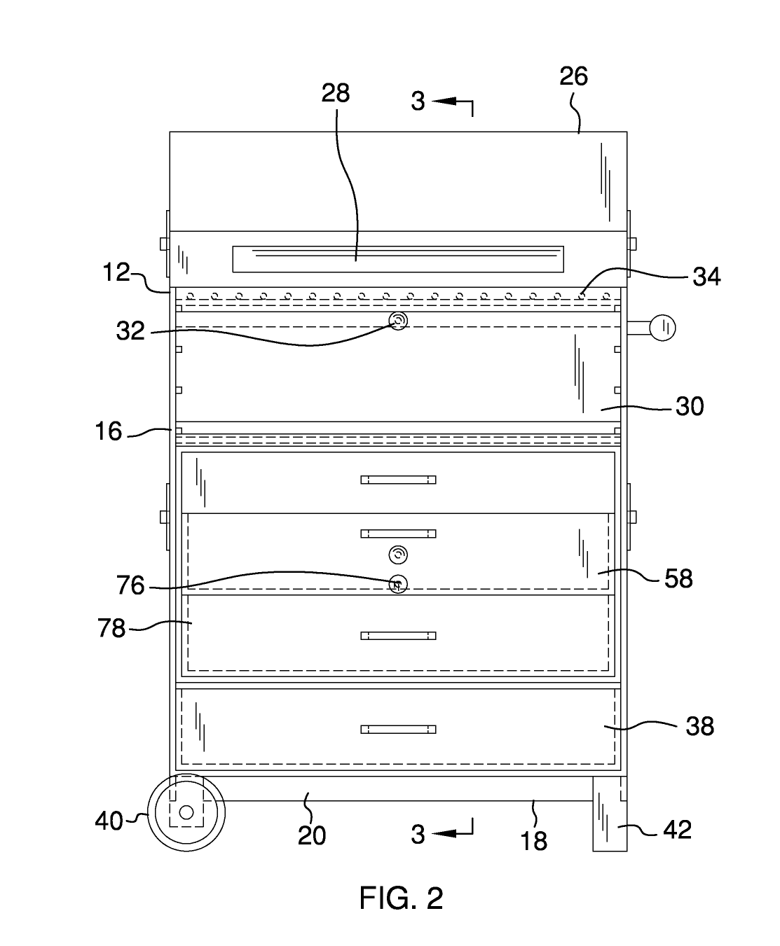

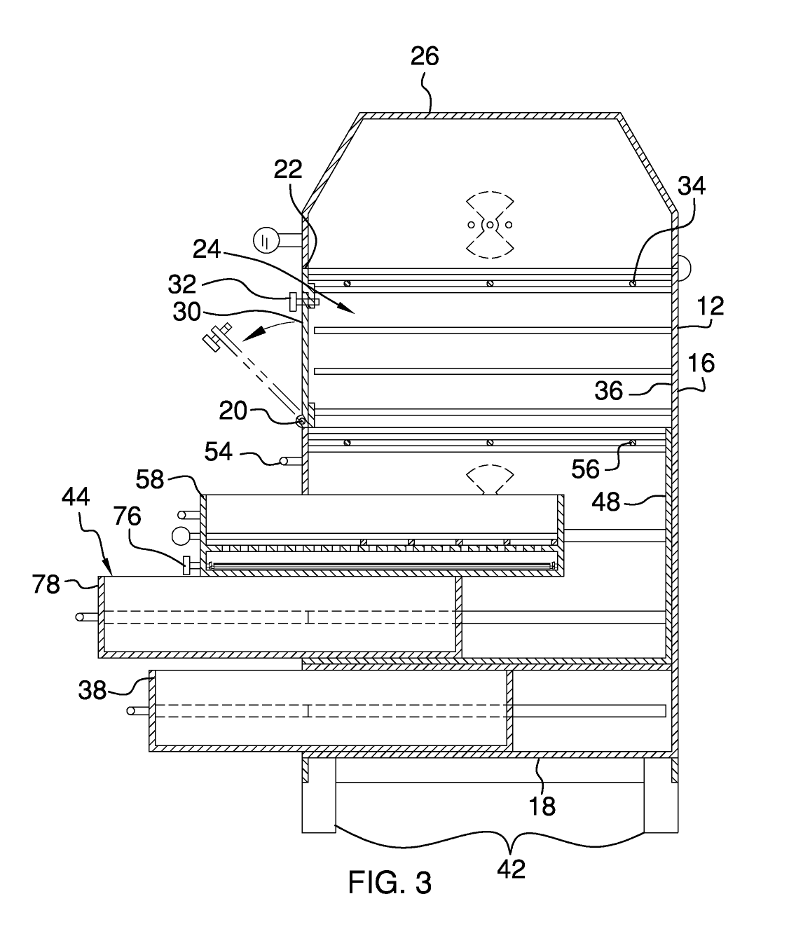

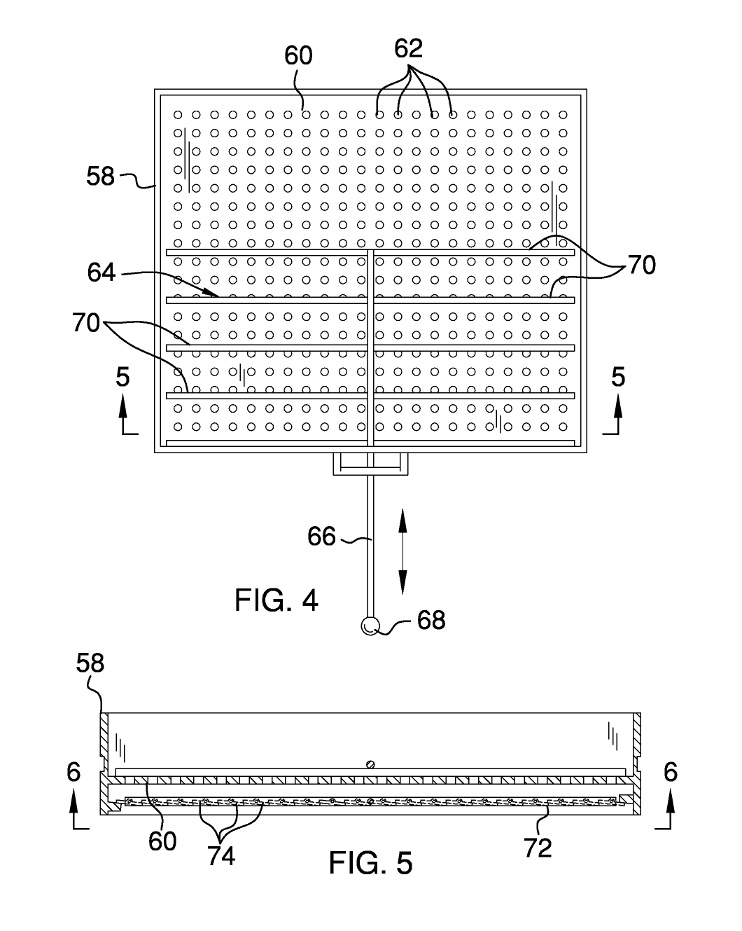

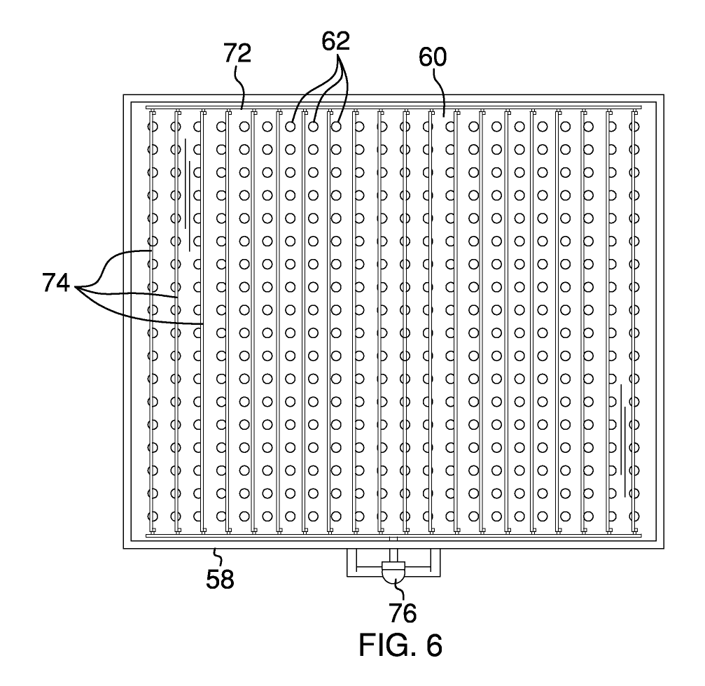

With reference now to the drawings, and in particular to FIGS. 1 through 6 thereof, a new cooking device embodying the principles and concepts of an embodiment of the disclosure and generally designated by the reference numeral 10 will be described.

As best illustrated in FIGS. 1 through 6, the cooking assembly 10 generally comprises a housing 12 that may contain a food item 14. The housing 12 has an outer wall 16 and the outer wall 16 has a bottom side 18 and a front side 20. The front side 20 is open to access an interior of the housing 12. The outer wall 16 has a distal edge 22 with respect to the bottom side 18 and the distal edge 22 defines an opening 24 into the housing 12.

A cover 26 is hingedly coupled to the housing 12. The cover 26 is positionable in an open position and a closed position. The cover 26 is positioned on the distal edge 22 such that the cover 26 selectively covers and exposes the opening 24. A handle 28 is coupled to the cover 26.

A door 30 is hingedly coupled to the housing 12. The door 30 is positionable in an open position and a closed position. The door 30 is positioned on the front side 20. A knob 32 is coupled to the door 30 and the knob 32 may be gripped to manipulate the door 30.

A first grill 34 is removably positioned within the housing 12 and the first grill 34 may support the food item 14. The first grill 34 is positioned within the opening 24. The first grill 34 engages an inside surface 36 of the housing 12 at a selected point. Thus, the first grill 34 is positionable at a selected distance from the distal edge 22 of the housing 12. The door 30 is positioned in the open position to facilitate the grill 34 to be positioned at the selected point.

A drawer 38 is slidably coupled to the housing 12. The drawer 38 is positioned on the front side 20. The drawer 38 is slidable outwardly from the front side 20. The drawer 38 may contain cooking utensils or other objects.

A pair of wheels 40 is each rotatably coupled to the bottom side 18 of the housing 12. Each of the wheels 40 may roll along a support surface. A pair of legs 42 is each coupled to and extends downwardly from the bottom side 18. Each of the legs 42 abuts the support surface when the housing 12 is stationary on the support surface.

A cooker 44 is removably positioned within the housing 12. The cooker 44 may have a combustible material 46 positioned therein. Thus, the food item 14 may be cooked when the cooker 44 is positioned within the housing 12. The cooker 44 is removable from the housing 12. Thus, the cooker 44 may cook the food item 14 in a remote location with respect to the housing 12. The combustible material 46 may comprise charcoal or the like.

The cooker 44 comprises a box 48 that has a front side 50 and a top side 52. The top side 52 is open and the box 48 is slidably inserted into the front side 20 of the housing 12. The box 48 is positioned between the door 30 and the drawer 38. A handle 54 is coupled to the box 48 thereby facilitating the box 48 to be manipulated.

A second grill 56 is removably positioned within the box 48. The second grill 56 may support the food item 14 when the cooker 44 is removed from the housing 12. The second grill 56 is aligned with the top side 52 of the box 48. The second grill 56 is aligned with the first grill 34 when the box 48 is inserted into the housing 12.

A primary drawer 58 is slidably coupled to the box 48. The primary drawer 58 is slidably outwardly from the front side 50 of the box 48. The primary drawer 58 has a basal wall 60 and the basal wall 60 may have the combustible material 46 placed thereon. The basal wall 60 has a plurality of openings 62 extending therethrough. The openings 62 are spaced apart from each other and distributed on the basal wall. Each of the openings 62 may have ash from the combustible material 46 pass therethrough.

An agitator 64 is movably coupled to the primary drawer 58. The agitator 64 may be manipulated thereby facilitating the agitator 64 to agitate the combustible material 46. The agitator 64 comprises a rod 66 extending through the front side 50 of the box 48. The rod 66 has a distal end 68 with respect to the front side 50 of the box 48 and the distal end 68 may be gripped. The agitator 64 is urged backwardly and forwardly in the primary drawer 58 to dislodge ash created by combustion of the combustible material 46.

The agitator 64 further comprises a plurality of arms 70. Each of the arms 70 is coupled to and extends away from the rod 66. Each of the arms 70 engages the combustible material 46 when the rod 66 is manipulated. The arms 70 are spaced apart from each other and distributed along the rod 66.

A shutter 72 is movably coupled to the box 48 and the shutter 72 is spaced from the basal wall 60. The shutter 72 comprises a plurality of slats 74. Each of the slats 74 are rotatably coupled the shutter 72. The slats 74 are spaced apart from each other and are distributed along the box 48.

Each of the slats 74 is positionable in a closed position such that each of the slats 74 is oriented parallel with the basal wall 60. Thus, the shutter 72 inhibits the ash from passing through the box 48. Each of the slats 74 is positionable in an open position such that each of the slats 74 is oriented perpendicular to the basal wall 60. Thus, the shutter 72 allows the ash to pass through the box 48. A knob 76 is mechanically coupled to the shutter 72. The knob 76 extends outwardly through the front side 50 and the knob 76 may be manipulated. The knob 76 urges each of the slats 74 between the open position and the closed position.

A bin 78 is slidably coupled to the cooker 44. The bin 78 is slidable outwardly from the front side 50 of the cooker 44. The bin 78 is positioned beneath the primary drawer 58. Thus, the bin 78 captures the ash released from the primary drawer 58.

In use, the cooker 44 is positioned within the housing 12 and the housing 12 is utilized in the convention of a charcoal grill. The combustible material 46 is placed within the primary drawer 58 and the combustible material 46 is burned. The food item 14 is placed on the first grill 34 and the food item 14 is cooked. The cooker 44 is removed from the housing 12 to facilitate the cooker 44 to be portable. The food item 14 is placed on the second grill 56 and the food item 14 is cooked. The bin 78 is emptied when the bin 78 becomes full of ash.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A cooking assembly comprising:
a housing being configured to contain a food item;
a first grill being removably positioned within said housing such that said first grill is configured to support the food item; and
a cooker being removably positioned within said housing, said cooker being configured to contain a combustible material thereby facilitating the food item to be cooked when said cooker is positioned within said housing, said cooker being removable from said housing wherein said cooker is configured to cook the food item in a remote location with respect to said housing.

2. The assembly according to claim 1, wherein said housing has an outer wall, said outer wall having a bottom side and a front side, said front side being open to access an interior of said housing, said outer wall having a distal edge with respect to said bottom side, said distal edge defining an opening into said housing.

3. The assembly according to claim 2, further comprising a cover being hingedly coupled to said housing such that said cover is positionable in an open position and a closed position, said cover being positioned on said distal edge such that said cover selectively covers and exposes said opening.

4. The assembly according to claim 2, further comprising a door being hingedly coupled to said housing such that said door is positionable in an open position and a closed position, said door being positioned on said front side.

5. The assembly according to claim 2, further comprising a drawer being slidably coupled to said housing, said drawer being positioned on said front side such that said drawer is slidable outwardly from said front side.

6. The assembly according to claim 1, wherein:
said housing has a front side, a door, a drawer and a first grill; and
said cooker comprises:
a box having a front side and a top side, said top side being open, said box being slidably inserted into said front side of said housing such that said box is positioned between said door and said drawer; and
a second grill being removably positioned within said box wherein said second grill is configured to support the food item when said cooker is removed from said housing, said second grill being aligned with said top side of said box, said second grill being aligned with said first grill when said box is inserted into said housing.

7. The assembly according to claim 6, further comprising a primary drawer being slidably coupled to said box, said primary drawer being slidable outwardly from said front side of said box, said primary drawer having a basal wall wherein said basal wall is configured to have to combustible material placed thereon, said basal wall having a plurality of openings extending therethrough wherein each of said openings is configured to have ash from the combustible material pass therethrough.

8. The assembly according to claim 7, further comprising an agitator being movably coupled to said primary drawer wherein said agitator is configured to be manipulated thereby facilitating said agitator to agitate the combustible material.

9. The assembly according to claim 8, wherein said agitator comprises:
a rod extending through said front side of said box, said rod having a distal end with respect to said front side of said box wherein said distal end is configured to be gripped, and
a plurality of arms, each of said arms being coupled to and extending away from said rod wherein each of said arms is configured to engage the combustible material when said rod is manipulated, said arms being spaced apart from each other and distributed along said rod.

10. The assembly according to claim 6, further comprising a shutter being movably coupled to said box, said shutter being spaced from said basal wall.

11. The assembly according to claim 10, wherein said shutter comprises:
a plurality of slats, each of said slats being positionable in a closed position such that each of said slats is oriented parallel with said basal wall wherein said shutter is configured to inhibit the ash from passing through said box, each of said slats being positionable in an open position such that each of said slats is oriented perpendicular to said basal wall wherein said shutter is configured to allow the ash to pass through said box; and
a knob being mechanically coupled to said shutter, said knob extending outwardly through said front side wherein said knob is configured to be manipulated, said knob urging each of said slats between said open position and said closed position.

12. The assembly according to claim 7, further comprising a bin being slidably coupled to said cooker, said bin being slidable outwardly from said front side of said cooker, said bin being positioned beneath said primary drawer wherein said bin is configured to capture the ash released from said primary drawer.

13. A cooking assembly comprising:
a housing being configured to contain a food item, said housing having an outer wall, said outer wall having a bottom side and a front side, said front side being open to access an interior of said housing, said outer wall having a distal edge with respect to said bottom side, said distal edge defining an opening into said housing;
a cover being hingedly coupled to said housing such that said cover is positionable in an open position and a closed position, said cover being positioned on said distal edge such that said cover selectively covers and exposes said opening;
a door being hingedly coupled to said housing such that said door is positionable in an open position and a closed position, said door being positioned on said front side;
a first grill being removably positioned within said housing such that said first grill is configured to support the food item, said first grill being positioned within said opening;
a drawer being slidably coupled to said housing, said drawer being positioned on said front side such that said drawer is slidable outwardly from said front side; and
a cooker being removably positioned within said housing, said cooker being configured to contain a combustible material thereby facilitating the food item to be cooked when said cooker is positioned within said housing, said cooker being removable from said housing wherein said cooker is configured to cook the food item in a remote location with respect to said housing, said cooker comprising:
a box having a front side and a top side, said top side being open, said box being slidably inserted into said front side of said housing such that said box is positioned between said door and said drawer,
a second grill being removably positioned within said box wherein said second grill is configured to support the food item when said cooker is removed from said housing, said second grill being aligned with said top side of said box, said second grill being aligned with said first grill when said box is inserted into said housing,
a primary drawer being slidably coupled to said box, said primary drawer being slidably outwardly from said front side of said box, said primary drawer having a basal wall wherein said basal wall is configured to have to combustible material placed thereon, said basal wall having a plurality of openings extending therethrough wherein each of said openings is configured to have ash from the combustible material pass therethrough,
an agitator being movably coupled to said primary drawer wherein said agitator is configured to be manipulated thereby facilitating said agitator to agitate the combustible material, said agitator comprising:
a rod extending through said front side of said box, said rod having a distal end with respect to said front side of said box wherein said distal end is configured to be gripped, and
a plurality of arms, each of said arms being coupled to and extending away from said rod wherein each of said arms is configured to engage the combustible material when said rod is manipulated, said arms being spaced apart from each other and distributed along said rod;
a shutter being movably coupled to said box, said shutter being spaced from said basal wall, said shutter comprising:
a plurality of slats, each of said slats being positionable in a closed position such that each of said slats is oriented parallel with said basal wall wherein said shutter is configured to inhibit the ash from passing through said box, each of said slats being positionable in an open position such that each of said slats is oriented perpendicular to said basal wall wherein said shutter is configured to allow the ash to pass through said box, and
a knob being mechanically coupled to said shutter, said knob extending outwardly through said front side wherein said knob is configured to be manipulated, said knob urging each of said slats between said open position and said closed position; and
a bin being slidably coupled to said cooker, said bin being slidable outwardly from said front side of said cooker, said bin being positioned beneath said primary drawer wherein said bin is configured to capture the ash released from said primary drawer.
